(19) United States
(12) Patent Application Publication
(10) Pub. No.: US 2005/0001941 A1
(43) Pub. Date: Jan. 6, 2005

(54) Deflection yoke and color picture tube apparatus

(76) Inventor: Etsuji Tagami, Takatsuki-shi (JP)

Correspondence Address: SNELL & WILMER L.L.P., Suite 1200, 1920 Main Street,, Irvine, CA, 92614-7230, US

(21) Appl. No.: 10/850,777

(22) Filed: May 20, 2004

(30) Foreign Application Priority Data
May 27, 2003 (JP) JP2003-149772

(51) Int. Cl. H04N 5/655

(52) U.S. Cl. 348/829

(57) ABSTRACT

A deflection yoke mounted on a periphery of a picture tube includes a funnel-shaped resin frame, a pair of deflection coils, and a bias member. The deflection coils oppose each other across a tube axis of the picture tube, each deflection coil has a plurality of winding turns that are loop-shaped and provided along an inner surface of the resin frame, and each deflection coil is composed of (i) a fixed coil that is fixed to the resin frame and includes an outermost of the winding turns, and (ii) a movable coil that is movably provided with respect to the inner surface of the resin frame. The bias member biases the movable coil toward the tube axis.

This application is based on application No. 2003-149772 filed in Japan, the contents of which are hereby incorporated by reference.

### BACKGROUND OF THE INVENTION

(1) Field of the Invention

The present invention relates to a deflection yoke and a color picture tube apparatus, and in particular to the structure of a deflection yoke that is mounted on a periphery of a color picture tube.

(2) Related Art

When assembling a color picture tube apparatus, the position of the deflection yoke is adjusted backward or forward in a tube axis direction of the color picture tube, as part of color purity adjustment. Color purity adjustment is for adjusting the electron beams corresponding to R (red), G (green) and B (blue) that are emitted from an electron gun, so that the electron beams hit the phosphor of the corresponding color correctly in order to obtain an even raster without inconsistencies on the surface of the color picture tube.

The following describes the aforementioned adjustment of the deflection yoke (hereinafter referred to as YPB (Yoke Pullback) adjustment. First, the deflection yoke is mounted on the picture tube, and pushed as far as possible forward (toward the funnel). Next, after the electron beams have been set so that monochrome raster is displayed, in other words, so that only the electron beam corresponding to green, for example, is emitted, the deflection yoke is pulled backward so that the whole of the tube surface displays the one color green.

Next, the raster is successively switched to other single colors in order to check that no inconsistencies are exhibited in red and blue. The deflection yoke is finely adjusted slightly forward or backward if inconsistencies are found.

When a position at which it is confirmed that there are no inconsistencies in any of the single colors has been found in this way, the deflection yoke is fixed in place at that position on the picture tube.

YPB adjustment such as described is unnecessary if the picture tube and the deflection yoke are fabricated ideally (able to be fabricated as designed). However, such precision is difficult to achieve in actual mass production, and is as yet unrealistic. For this reason, the deflection yoke is positioned such that there is some allowance to adjust the deflection yoke backward or forward in the picture tube axis direction (hereinafter, this allowance in positioning is referred to as a “color purity allowance”) with reference to a particular position (hereinafter, referred to as a “pullback reference position”), and the deflection yoke is adjusted within this range. This color purity allowance is expressed as the distance that the deflection yoke is able to move in the tube axis direction, and is generally set at approximately 2 mm. Furthermore, the pullback reference position is generally set so as to be a position that is 2 mm backward, in the tube axis direction, of the position that is as far forward as the deflection yoke is able to be pushed. In other words, the deflection yoke is positioned so as to be able to move backward in a range of 1 mm to 3 mm in the tube axis direction from the position that is as far forward as the deflection yoke is able to be pushed.

Note that in the present specification, the final position at which the deflection yoke is fixed in place is referred to as the “pullback position”, and the distance, in the tube axis direction, from the position that is as far forward (toward the funnel) as the deflection yoke is able to be pushed to the pullback position is referred to as the “pullback distance”.

Since the pullback position is determined in a range of a pullback distance of 1 mm to 3 mm in the YPB adjustment as described, the deflection yoke is fixed in place with a commensurate gap between the deflection yoke and the picture tube. The deflection power is set based on the assumption that such a gap will exist.

### SUMMARY OF THE INVENTION

The first object of the present invention is to provide a deflection yoke that is fixed to a picture tube after being subject to YPB adjustment, and enables deflection power to be reduced.

The second object of the present invention is to provide a color picture tube apparatus that incorporates such a deflection yoke.

The stated first object is achieved by a deflection yoke mounted on a periphery of a picture tube, including: a funnel-shaped resin frame; a pair of deflection coils, the deflection coils opposing each other across a tube axis of the picture tube, each deflection coil having a plurality of winding turns that are loop-shaped and provided along an inner surface of the resin frame, and each deflection coil being composed of (i) a fixed coil that is fixed to the resin frame and includes an outermost of the winding turns, and (ii) a movable coil that is movably provided with respect to the inner surface of the resin frame; and a bias member for biasing the movable coil toward the tube axis.

According to the stated structure, since the movable coil which is movably provided with respect to the inner surface of the resin frame is biased toward the tube axis of the picture tube, after the deflection yoke has been pulled back in YPB adjustment, the movable coil is closer to the tube axis in proportion to a gap that results between the picture tube in accordance with the pullback distance. In other words, the movable coil is closer to the area where the electron beams pass through the picture tube. As a result, compared to a conventional deflection yoke in which the distance between the deflection coil and the tube axis changes very little regardless of the position determined in YBP adjustment, according to the deflection yoke of the present invention, the closer the movable coil is to the tube axis, the more the deflection power can be reduced.

The stated second object is achieved by a color picture tube apparatus that includes the described deflection yoke.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a side view showing an overview of the structure of a color picture tube apparatus;

FIG. 2 is a cross sectional view of part of an upper half of the color picture tube cut on a YZ plane and slightly offset in an X axis direction from a start point, in an XYZ orthogonal coordinate system in which the tube axis of the color picture tube is a Z axis;

FIG. 3 is a perspective view of a deflection yoke as seen in a diagonal direction from a panel-side;

FIG. 4A is a planar view of a bias member in a state in which a movable coil is attached, and FIG. 4B is an A-A cross-sectional view of FIG. 4A;

FIG. 5 is a connection diagram of a horizontal deflection coil and a differential coil;

FIG. 6 is a cross sectional view of part of an upper half of the color picture tube cut on a YZ plane and slightly offset in an X axis direction from a point of origin, and shows the color picture tube during YPB adjustment; and

FIG. 7 is a cross-sectional view of part of an upper half of a color picture tube in another embodiment, cut on a YZ plane that includes a Z axis.

### DESCRIPTION OF THE PREFERRED EMBODIMENT

The following describes an embodiment of the present invention with reference to the drawings.

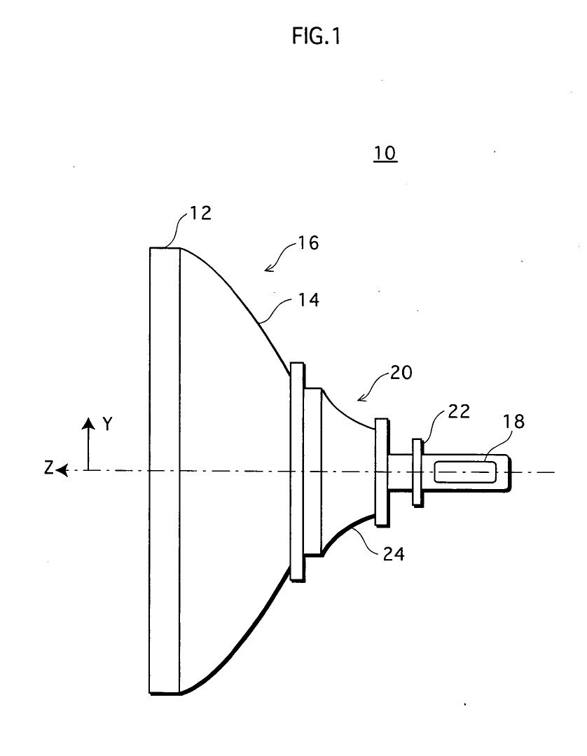

FIG. 1 is side view showing an overview of the structure of a color picture tube apparatus 10 of the present embodiment. Note that the color picture tube apparatus 10 is a 36-inch picture tube apparatus with an aspect ratio of 16:9 and a deflection angle of 102°. The color picture tube apparatus 10 is composed of a glass bulb 16 that is made up of a front flat panel 12 (hereinafter, simply referred to as a “panel”) which has a phosphor screen formed on the inner surface, and a funnel 14 that are joined together; an inline electron gun 18 that is provided in a neck portion of the funnel 14; a deflection yoke 20 mounted on a periphery of the funnel 14; and a convergence yoke 22. The funnel 14 is, literally, funnel shaped, and its external shape is substantially pyramidal, smoothly transitioning from the round neck through to the substantially square front plane panel 12. Note that FIG. 1 is merely for indicating the positional relationship of the described members, and illustrates the deflection yoke 20 and the other members extremely simply.

In the present embodiment, the tube axis of the color picture tube is made to coincide with a Z axis, and an XYZ orthogonal coordinate system is used. Here, an X axis direction is the horizontal direction and a Y axis direction is the vertical direction.

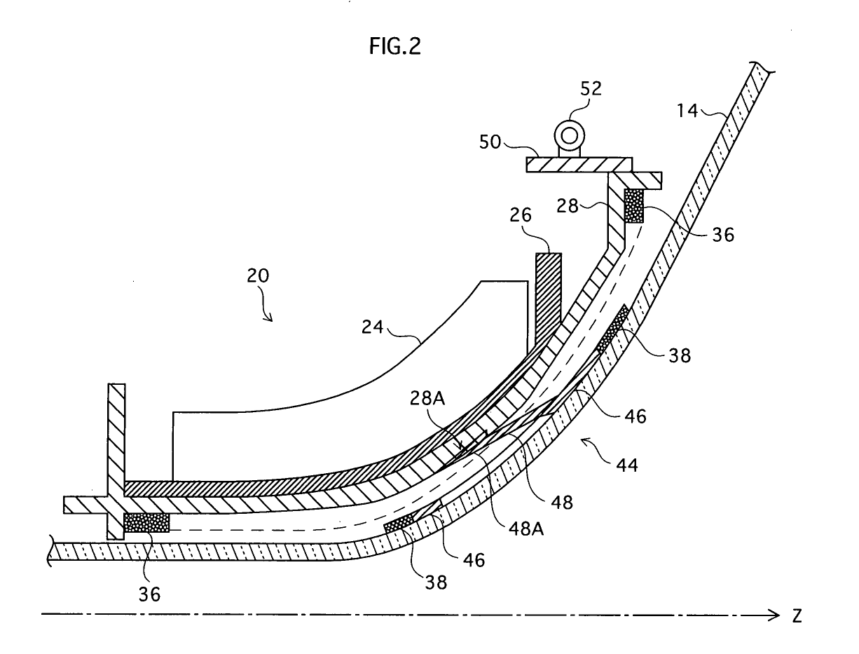

FIG. 2 is a cross-sectional view of part of an upper half of the color picture tube apparatus 10 cut on an YZ plane that is slightly offset in an X axis direction from a point of origin.

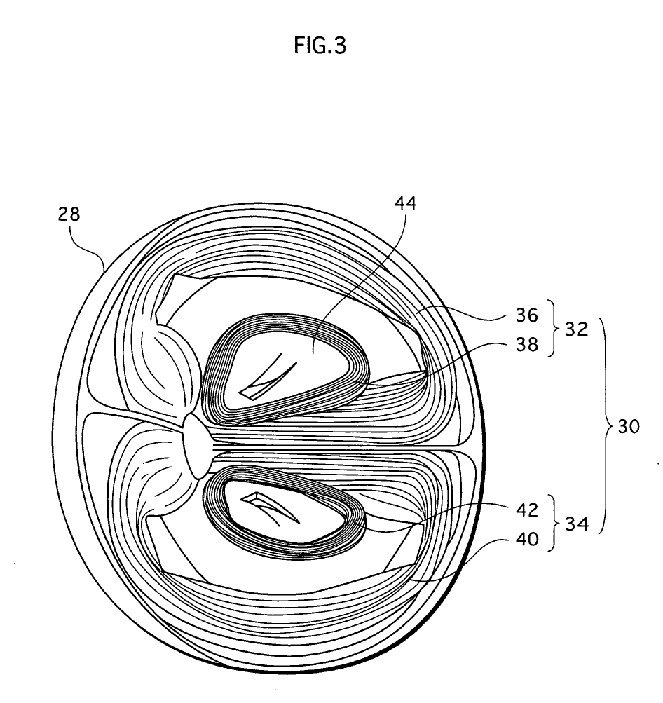

As shown in FIG. 2, the deflection yoke 20 is composed of a vertical deflection coil 26 wound in a saddle-shape, a resin frame 28, and a horizontal deflection coil 30 (see FIG. 3), parts of which are indicated by numerical references 36 and 38, provided in the stated order on an inner side of a ferrite core 24.

The deflection yoke 20 is provided on the funnel 14 on a peripheral area where the cross-sectional peripheral shape, when cut on a plane vertical to the Z axis (an XY plane), spans a round-shaped area through to a substantially rectangular area from the neck portion toward the panel 12. The peripheral area of the funnel 14 on which the deflection yoke is mounted is called the “yoke mounting portion” in the present specification.

FIG. 3 is a perspective view of a deflection yoke as seen in a diagonal direction from a panel 12 side.

The resin frame 28 has a funnel shape that conforms to the external shape of the yoke mounting portion of the funnel 14. As described, the vertical deflection coil 26 (not illustrated in FIG. 3) is disposed on the outer surface of the resin frame 28 and the horizontal deflection coil 30 is disposed on the inner surface of the resin frame 28, and the resin frame 28 serves as insulation that electrically isolates the deflection coils 26 and 30 from each other.

The horizontal deflection coil 30 is composed of an upper horizontal deflection coil 32 and a lower horizontal deflection coil 34 that are provided opposing each other across the Z axis.

The upper horizontal deflection coil 32 is divided into a fixed coil 36 that is fixed to the inner surface of the resin frame 28 and a movable coil 38 that is movable with respect to inner surface of the resin frame 28. Similarly, the lower deflection coil 34 is divided into a fixed coil 40 that is fixed to the inner surface of the resin frame 28 and a movable coil 42 that is movable with respect to inner surface of the resin frame 28.

Since the upper horizontal deflection coil 32 and the lower horizontal deflection coil 34 are symmetrical with respect to an XZ plane and have identical structures, the following describes the structure of the upper horizontal deflection coil 32 as a representative of the two.

The fixed coil 36 is fabricated separately by winding wire into a saddle shape using a mold, and is adhered to the inner surface of the resin frame 28 to be fixed in place. Note that the wind count of the fixed coil 36 is 40.

The movable coil 38 is also fabricated separately to the fixed coil 36 by winding wire using a mold. In other words, rather than successively winding one wire, (either a single wire or a stranded wire), the movable coil 38 and the fixed coil 36 are fabricated by winding separate wires. The wind count of the movable coil 38 is 8.

The movable coil 38 is mounted to the insulation frame 28 via the bias member 44.

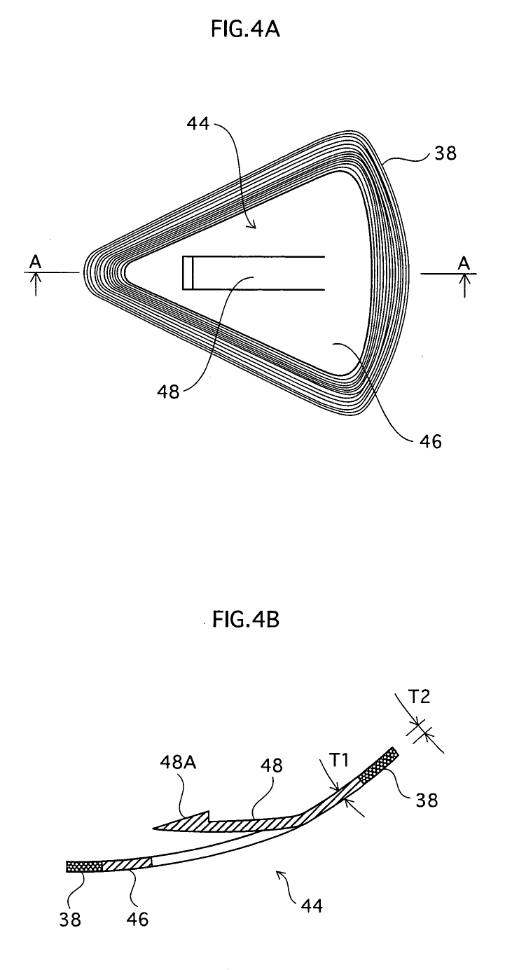

FIG. 4A is a planar view of the bias member 44 in a state in which the movable coil 38 is mounted, and FIG. 4B shows an A-A cross-section of FIG. 4A.

The bias member 44 is composed of a coil mounting part 46 and a flexible support part 48. The coil mounting part 46 is a plate made of resin, and is formed so that the outer shape thereof conforms to the inner shape of the movable coil 38. The flexible support part 48 is a strip-shaped flexible piece that extends from one side of a square opening provided in a central part of the resin plate, and, as described later, flexibly supports the coil mounting part 46 with respect to the resin frame 28. A claw 48A is formed at the tip portion of the flexible support part 48.

The movable coil 38 is fitted together with the coil mounting part 46, and the inner surface of the movable coil 38 and the outer surface of the coil mounting part 46 are fixed together with adhesive. Note that the thickness T1 of the coil mounting part 46 and the thickness T2 of the movable coil 38 are both 1 mm.

The bias member 44 to which the movable coil 38 has been fixed is mounted on the resin frame 28.

Returning to FIG. 2, the resin frame 28 is provided with a depression 28A whose shape corresponds to the claw 48A. The claw 48A is fitted into the depression 28A and fixed with adhesive, thereby attaching the bias member 44 to the resin frame 28.

Note that the movable coil 38 and the fixed coil 36 are electrically connected on a terminal board 50 provided at the top of the insulation frame 28. Furthermore, a differential coil 52 is provided on the terminal board 50.

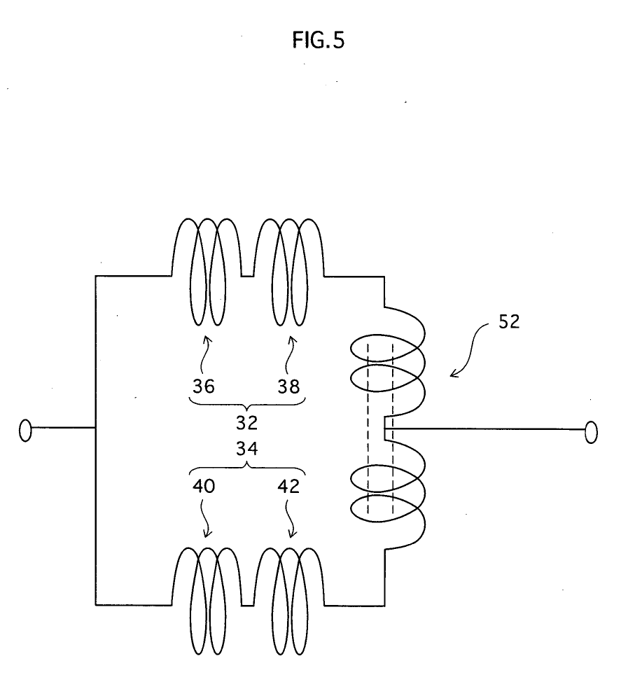

A connection diagram of the horizontal deflection coil 30 and the differential coil 52 is shown in FIG. 5.

As shown in FIG. 5, the fixed coil 36 and the movable coil 38 are connected in series to form the upper horizontal deflection coil 32, and the fixed coil 40 and the movable coil 42 are connected in series to form the lower horizontal deflection coil 34. The upper horizontal deflection coil 32 and the lower horizontal deflection coil 34 are connected in parallel via the differential coil 52.

The deflection coil 20 having the described structure is subject to YPB adjustment and then fixed on the color picture tube.

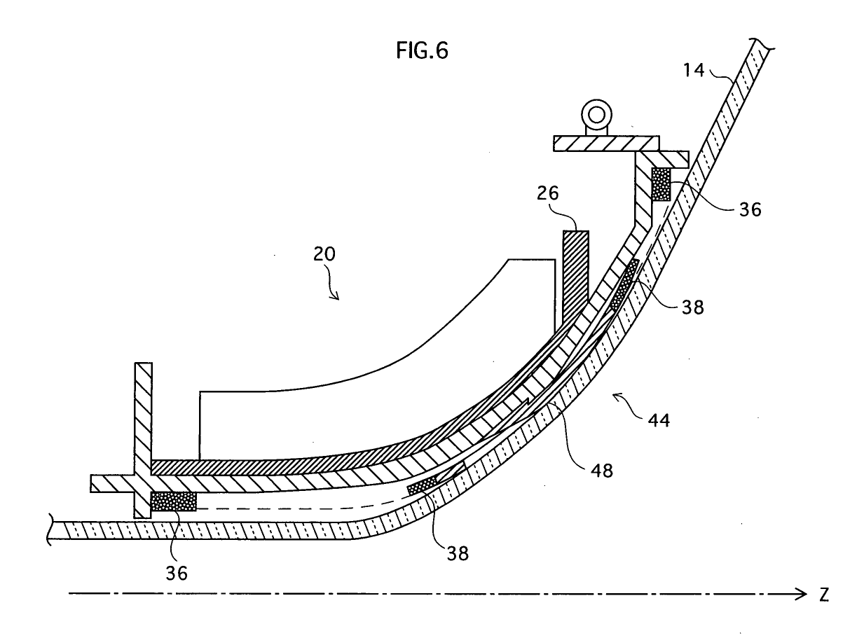

As described earlier, the deflection yoke 20 is first slid onto the picture tube, and pushed as far forward as possible in the Z axis direction (toward the panel 12). The state of the deflection yoke 20 pushed as far as possible is shown in FIG. 6. As shown in FIG. 6, the bias member 44 and the movable coil 38 are pushed against the outer surface of the funnel 14, and the flexible support part 48 is flexed out of its natural state shown in FIG. 4B.

The deflection coil 20 is pulled backward in the Z axis direction (toward the electron gun) from the state shown in FIG. 6, and a position at which no irregularities are exhibited in the raster of each color is determined (pullback position). The deflection coil 20 is fixed with respect to the color picture tube in that position.

FIG. 2 shows the state of the deflection coil 20 in the pullback position. Although overall the deflection coil 20 moves backward in the Z direction, due to the resilience of the flexible support part 48, the movable coil 38 (and the movable coil 42) is displaced so as to contact the outer surface of the funnel 14 in a Y axis direction toward the Z axis.

Conventionally, the distance of the horizontal deflection yoke from the Z axis (the tube axis) does not change, regardless of the position determined as the pullback position in the YPB adjustment. In contrast, in the deflection yoke 20 of the present embodiment, the movable coils 38 and 42 are displaced in the Y axis direction toward the Z axis in accordance with the pullback position, in other words, in accordance with the size of the gap between the funnel 14 and the outer surface. In other words, the movable coils 38 and 42 become closer to the area through which the electron beams pass in the color picture tube. As a result, the deflection power required to generate the necessary horizontal deflection magnetic field is commensurately reduced.

Ordinarily, the pullback position determined in YPB adjustment is in a range of 1 mm backward or forward of a position of a pull back distance (pull back reference position) of 2 mm (in other words, a pullback distance range of 1 mm to 3 mm). In other words, a gap is usually present between the inner surface of the deflection yoke and the outer surface of the funnel after YPB adjustment, and the movable coil becomes closer to the Z axis (the tube axis) in accordance with the size of the gap. Consequently, the closer the movable coil is to the Z axis, the more the design value of the horizontal deflection power can be reduced compared to a conventional deflection yoke.

Specifically, it has been confirmed that the horizontal deflection power can be set to 28.5 mHA² in the color picture tube of the present embodiment, which is a 5% reduction of a horizontal deflection power design value of 30 mHA² in conventional color picture tube in which the movable coil in a deflection yoke having the same specifications is adhesively fixed to the resin frame.

Although the present invention has been described based on a preferred embodiment, the present invention is not limited to the described embodiment. Embodiments such as the following are also possible.

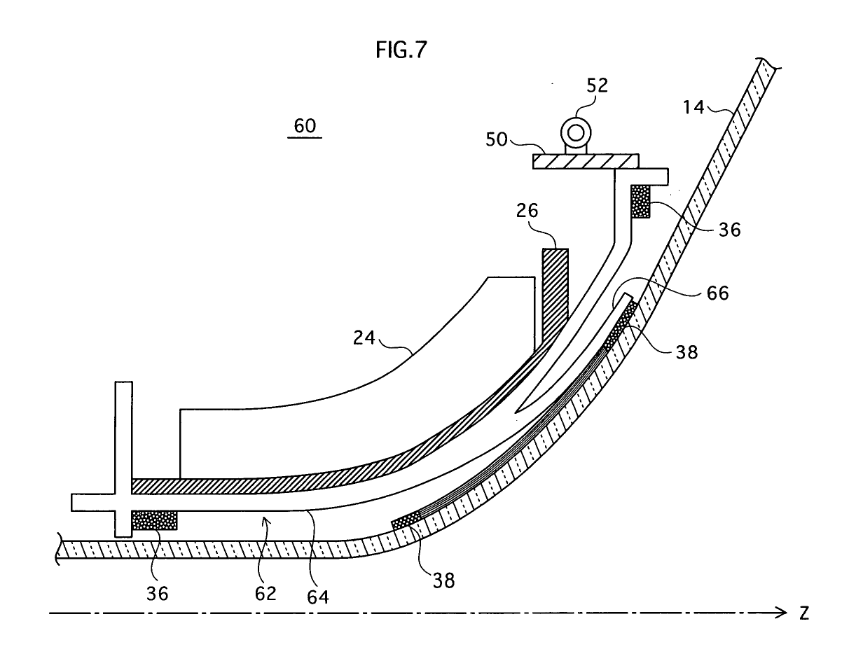

(1) The bias member that attaches the movable coil to the resin frame is not limited to being provided separately to the resin frame as described in the preferred embodiment. As shown in FIG. 7, the bias member may be part of the resin frame. FIG. 7 is a cross-sectional diagram showing part of the upper half of a color picture tube apparatus 60 of another embodiment, cut on a YZ plane that includes a point of origin. Note that structural members having the same structure as those in the color picture tube apparatus 10 in the described preferred embodiment have the same numerical references thereas, and are omitted from the following description.

A resin frame 62 in the color picture tube apparatus 60 is divided into two at the YZ plane, and has a two-piece structure consisting of two resin frame components which form a funnel shape when assembled. One resin frame component 64 (on a right-hand side as seen from the phosphor screen side) appears in FIG. 7. Note that the resin frame component 64 is symmetrical to the other resin frame component (not illustrated) with respect to the YZ plane.

The resin frame component 64 has a flexible member 66 that is a strip-shaped flexible piece that extends from the main body of the resin frame component 64. The movable coil 38 is adhered to the tip part of the flexible member 66 by adhesive.

According to the described structure, when the deflection yoke 60 is slid onto the picture tube and pushed as far forward as possible in the Z direction (toward the panel 12), the flexible member 66 flexes, and the movable coil 38 becomes closer to the main body of the resin frame in the same was as shown in FIG. 6.

The deflection yoke 60 is pulled backward in the Z axis direction (toward the electron gun side) from this state, and a position at which no inconsistencies are exhibited in the raster of each color is determined (pullback position). The deflection coil 60 is fixed with respect to the color picture tube in that position.

FIG. 7 shows the state of the deflection yoke 60 in the pullback position. Although overall the deflection yoke 60 moves backward in the Z direction, due to the resilience of the flexible member 66, the movable coil 38 is displaced in a Y axis direction toward the Z axis so as to contact the outer surface of the funnel 14. This obtains the same effect as the deflection yoke 20 in the described preferred embodiment.

(2) In the preferred embodiment, the upper horizontal deflection coil and the lower horizontal deflection coil are divided into two winding turn bundles, in other words, the upper and lower horizontal deflection coils have a structure in which the fixed coil and the movable coil are separate. However, the upper and lower horizontal deflection coils are not limited to being divided into two winding turn bundles, and may be divided into N (N being a natural number) winding turn bundles. Furthermore, the number of winds of the wire in each winding turn bundle maybe determined freely. In addition, which of the winding turn bundles are fixed to the resin frame (insulation frame) and which of the winding turn bundles are separate from the fixed bundles (in other words, which are movable coils) may be determined arbitrarily. It is sufficient for at least one of the N separate winding turn bundles to be a movable coil.

However, it is necessary for the outermost winding bundle of each horizontal deflection coil to be a fixed coil. This is because, if the outermost winding turn bundle of each of the upper and lower horizontal deflection coils is a movable coil, the movable coils will come into contact with each other in YPB adjustment. In other words, the part of the winding turn that includes the outermost winding turn (one or a plurality of winding turn bundles) is made to be a fixed coil, and the remaining part of the winding turns (one or a plurality of winding turn bundles) is made to be a movable coil.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A deflection yoke mounted on a periphery of a picture tube, comprising:
a funnel-shaped resin frame;
a pair of deflection coils, the deflection coils opposing each other across a tube axis of the picture tube, each deflection coil having a plurality of winding turns that are loop-shaped and provided along an inner surface of the resin frame, and each deflection coil being composed of (i) a fixed coil that is fixed to the resin frame and includes an outermost of the winding turns, and (ii) a movable coil that is movably provided with respect to the inner surface of the resin frame; and
a bias member for biasing the movable coil toward the tube axis.

2. The deflection yoke of claim 1, wherein
the bias member includes:
a coil mounting part to which the movable coil is mounted; and
a flexible support part for flexibly supporting the coil mounting part with respect to the resin frame.

3. The deflection yoke of claim 1, wherein
the bias member is a flexible member that is a part of the resin frame that extends from a main body thereof.

4. The deflection yoke of claim 1, wherein
the movable coil and the fixed coil are wound from separate wires.

5. The deflection yoke of claim 1, wherein
the deflection coils are horizontal deflection coils.

6. A color picture tube apparatus that includes a deflection yoke according to claim 1.
